(19) United States
(12) Patent Application Publication
(10) Pub. No.: US 2026/0210123 A1
(43) Pub. Date: Jul. 23, 2026

(54) BUILDING FACADE PANEL, IN PARTICULAR PHOTOVOLTAIC FACADE PANEL, AND METHOD FOR INSTALLING SAME

(71) Applicant: SAINT-GOBAIN GLASS FRANCE, COURBEVOIE (FR)

(72) Inventors: Fabio FOTI, COURBEVOIE (FR); Christian GRANGER, COURBEVOIE (FR); Erwan BAQUET, COURBEVOIE (FR)

(21) Appl. No.: 19/140,787

(22) PCT Filed: Dec. 13, 2023
(86) PCT No.: PCT/EP2023/085509

§ 371 Date: Jun. 18, 2025

(30) Foreign Application Priority Data
Dec. 19, 2022 (FR) FR2213843

(51) Int. Cl. E04F 13/08; H02S 20/26

(52) U.S. Cl. CPC E04F 13/081; H02S 20/26

(57) ABSTRACT

A building facade panel having two opposite faces, including a so-called fastening face and including, on the fastening face, a fastening system including at least two parallel, spaced-apart fastening rails, at least a first anchoring part and a second anchoring part, which are spaced apart and coupled to each of the fastening rails, the panel including an adjustment system for leveling the panel, including at least one adjusting member which is arranged on the fastening face side and which engages with the fastening system, the adjusting member further including an actuating portion which protrudes from an edge of the panel.

The invention relates to the field of attaching elements to a building facade, such as photovoltaic panels.

The invention will be more particularly described with respect to the fastening of photovoltaic building facade panels, but without being limited thereto.

The invention is more particularly applicable to facade elements with a square or rectangular cross-section, but is not limited thereto.

Known systems for attaching photovoltaic panels to a building facade comprise, for one panel, at least two vertical fastening profiles (in the so-called Y direction) which are secured to the rear face of the panel adjacent to the vertical edges, and at least four anchoring parts which are removably attached in pairs to each of the two vertical profiles. The anchoring parts of each pair are spaced apart in the Y direction by a distance corresponding to the center distance of two horizontal mounting profiles, namely one lower and one upper (in the so-called X direction), which are secured to the building facade and with which said anchoring parts engage. The anchoring parts have an inverted U shape to straddle a flange of the mounting profiles of the building. Locking of the panel fastening is generally achieved at the upper end anchoring parts of the panel engaging with the upper mounting profile of the building, the anchoring parts having tabs which protrude from the upper edge of the panel to be accessible after panel installation and which are then screwed to the upper mounting profile.

However, such an fastening system has its drawbacks. Indeed, the anchoring parts are factory-fitted to the fastening profiles of the panel at a pre-determined center distance. Yet, on site, this center distance may not correspond perfectly to that of the mounting profiles of the wall of the building; in such cases, the panel has to be uninstalled, the anchoring parts have to be dismantled and repositioned at the correct height on the fastening profiles of the panel, and the panel has to be carried and hung again. However, once this adjustment has been made, even if the panel rests correctly against the upper and lower mounting profiles of the building, the panel may still not be level with those already installed. The whole operation then has to be repeated again dismantling, carrying, trying to more accurately adjust the height of the anchoring parts, then carrying and reassembling again.

As a result, today's panel fastening requires multiple on-site operations, from assembly and disassembly to adjustment and reassembly, and the weight of the panels is considerable. These tasks are awkward for operators, tiring and burdensome to keep their arms raised. The risk of developing musculoskeletal disorders is high. Additionally, these repeated interventions at height can be a safety hazard for operators, who may inadvertently drop a panel. Furthermore, this assembly and disassembly takes time during installation, which has an impact on labor time and, as a result, on installation costs.

The purpose of the invention is therefore to offer a building facade cladding panel, in particular a photovoltaic building facade panel, with an fastening system which makes it possible to limit or even avoid the aforementioned drawbacks, in particular the panel and its fastening system generating a method of installing said panel which is simple and quick to implement and provides leveling of the panel without the need to dismantle and reassemble it.

According to the invention, the building facade panel, in particular a photovoltaic building facade panel, has two opposite faces, including a so-called fastening face, and comprises, on the fastening face, an fastening system which comprises at least two parallel, spaced-apart fastening rails, at least a first anchoring part and a second anchoring part, which are spaced apart and coupled to each of the fastening rails, characterized in that said panel comprises an adjustment system for leveling the panel, comprising at least one adjusting member which is arranged on the fastening face side (extending parallel thereto) and which engages with the fastening system, the adjusting member further comprising an actuating portion which protrudes from an edge of the panel.

In this way, the fastening system of the invention makes it easy to install the facade panel on the mounting profiles of a building framework, and to level it in relation to the other panels already installed.

Panel leveling consists in arranging the panel so that it is perfectly parallel to adjacent panels already attached, and so that the separation gap with the other panels is constant on all sides. Generally, this gap is of the order of 10 mm. In this way, the adjustment system according to the invention can be used to accurately adjust the height of the panel once it has been hung on the building framework. In particular, the adjustment system can be used to compensate for play of plus or minus 5 mm in relation to the position of the anchoring parts, which have been factory-set to correspond normally to the center distance of the profiles or other mounting supports of the building framework. Since the adjusting member protrudes from the edge of the panel, the operator can intervene without dismantling the panel and view the adjustment in situ.

In the remainder of the description, the terms “horizontal”, “vertical”, “upper”, “lower”, “top”, “bottom” are used to describe elements used in the normal installation of a facade panel in order to install the facade panel in a vertical position on a building facade.

In the remainder of the description, the term “rear” is taken to mean that which faces or is intended to face the building, and the term “front” is taken to mean that which faces the outside environment, in front of the operator when installing a panel.

According to one feature, the adjusting member is a rotary member capable of transmitting a translational movement to the panel. Thus, when the panel is hung on the building framework owing to the anchoring parts, the operator simply turns the rotary member in one direction or the other to translate the panel (slightly—by a few millimeters) in relation to the building framework. The adjustment system is easy for the operator to use and is not physically demanding.

Advantageously, the adjusting member is coupled to the second anchoring part of an fastening rail, preferably the adjustment system comprising two adjusting members which are each coupled to the second anchoring part of the two fastening rails. The pair of adjusting members allows even more precise leveling and also provides a faster adjustment method, acting at both locations of the two second anchoring parts.

According to a first embodiment of the adjustment system, the adjusting member is a screw which engages with a second anchoring part, the second anchoring part being fixedly secured to the associated fastening rail and the panel being capable of translational movement when the screw is actuated. The screw acts as an adjusting member, enabling accurate adjustment of the position of the panel and thus its level. In this embodiment, the second anchoring part, which is fixed, is intended to remain fixed during adjustment; the second anchoring part is attached (preferably removably) to the associated fastening rail. The second anchoring part has a threaded housing for engagement with the screw. As a result, the panel in the hung position via the anchoring parts can be translated in a direction parallel to the fastening rails (direction parallel to the body of the rotary adjusting member-the screw), in one direction or the other, by screwing or unscrewing the screw, respectively. In addition, the adjusting member preferably comprises a locknut engaging with the screw to lock it in position (and as a result to lock it in position after the panel has been leveled).

In another embodiment of the adjustment system, the adjustment system is a screw-nut system and comprises the adjusting member as a screw and the second anchoring part as a nut, the second anchoring part being capable of translational movement when the screw is actuated. The translation of the second anchoring part generates the translation of the panel. Here too, the screw system allows accurate adjustment.

In yet another embodiment of the adjustment system, the adjustment system is a worm system, comprising on the one hand the adjusting member, which is a worm and carries the second anchoring part, and on the other hand a gear element for the worm, the second anchoring part being capable of translational movement when the worm is actuated. The translation of the second anchoring part generates the translation of the panel. Here too, the screw system provides accurate adjustment.

Preferably, the adjustment system comprises a position-locking element for the adjusting member, such as a locknut when the adjusting member is a screw, or a spring-return gear element when the adjusting member is a worm. The spring-return gear element has the advantage of automatically locking the worm in position.

Advantageously, the first and second anchoring parts each comprise a female shape, in particular an inverted U shape, intended to engage in the mounted position of the panel with a male shape of the building framework like a flange of a mounting profile or pin attached to a mounting profile.

Preferably, the building facade panel comprises a system for clamping the panel in the mounted position (advantageously, the clamping system is designed to be implemented after the panel has been leveled). The clamping system is intended to engage with the mounting framework of the panel, in particular in the manner of a jaw engaging with the flange of a mounting profile of the mounting framework of the building, or by abutting and capturing, with the second anchoring part, a support pin of a mounting profile.

According to one feature, the clamping system is attached to a second anchoring part, and comprises a portion which protrudes from an edge of the panel and which comprises clamping means locking said protruding portion in position, the clamping means preferably being by bolting. The protruding portion of the clamping system allows the operator to lock the panel in position by having direct access on the side of the panel. Advantageously, the clamping system is removably attached to said second anchoring part and is adjustable in position relative to said second anchoring part so as to adjust the position of the protruding portion comprising the clamping means. Preferably, the leveling adjusting member protrudes from a first side of the panel, while the part provided with clamping means protrudes from a second side of the panel.

In particular, the panel is mounted parallel to the facade, with at least the lower anchoring parts resting so as to abut and straddle the lower mounting profile of the building, and the panel can then be locked to prevent it from tipping, which is done simply by means of the clamping system, part of which protrudes laterally from the panel (in a plane parallel to the panel) so as to be accessible for clamping by the operator on the mounting profile or pin of the building.

The invention also relates to a method of attaching a building facade panel, as referred to above, in particular a photovoltaic building facade panel, to mounting profiles of the framework of a building, the method comprising the step of hanging the panel via the first and second anchoring parts, and being characterized in that it comprises, once the panel has been hung, a step of leveling the panel by actuating the actuating portion of at least one adjusting member protruding from one of the edges of the panel (thus rendered completely accessible), in particular by screwing or unscrewing the actuating portion, which allows the panel to be translated in one direction or the other by a few millimeters relative to the mounting profiles of the building framework. Adjustment is therefore carried out in situ, with the panel hanging in place, and is quick and easy, preferably by screwing or unscrewing the adjusting member. Preferably after leveling, the method comprises a step of clamping the panel in position by actuating clamping means of the clamping system, the clamping means protruding from one of the edges of the panel and being capable of locking the fastening of one of the anchoring parts to one of the mounting profiles of the building framework, in particular the clamping means being arranged so as to protrude from one of the edges perpendicular to the edge from which the adjusting member protrudes. Thus, since the clamping means are coupled to the anchoring part to which the adjusting member is attached, they are immediately within the operator's reach and accessible from the front, making panel clamping quick and easy.

The present invention is now described by means of examples that are solely illustrative and in no way limiting with respect to the scope of the invention, and on the basis of the attached illustrations, in which:

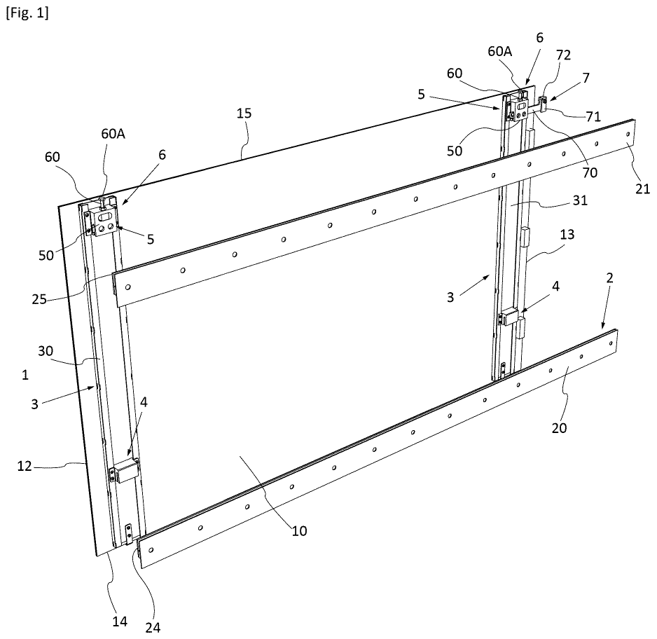

FIG. 1 shows a schematic perspective view of the rear of a facade panel according to a first example embodiment of the invention of the fastening system and the panel leveling adjustment system, the panel being intended for fastening to horizontal mounting profiles of a building facade framework, using two pairs of a first anchoring part and a second anchoring part.

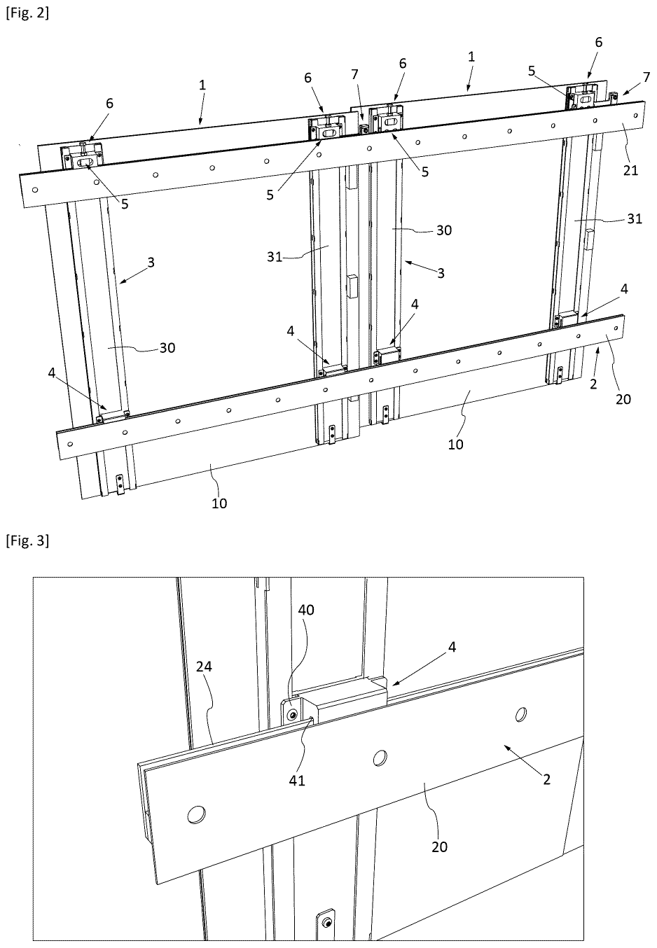

FIG. 2 shows a rear perspective view of part of a building facade, with the panel shown in FIG. 1 already attached and another panel being installed.

FIG. 3 is a detail view of FIG. 2 at a so-called lower panel fastening point, showing one of the first anchoring parts engaged with a mounting profile.

FIG. 4 is a detail view of FIG. 2 at a so-called upper panel fastening point, showing one of the second anchoring parts engaged with another mounting profile.

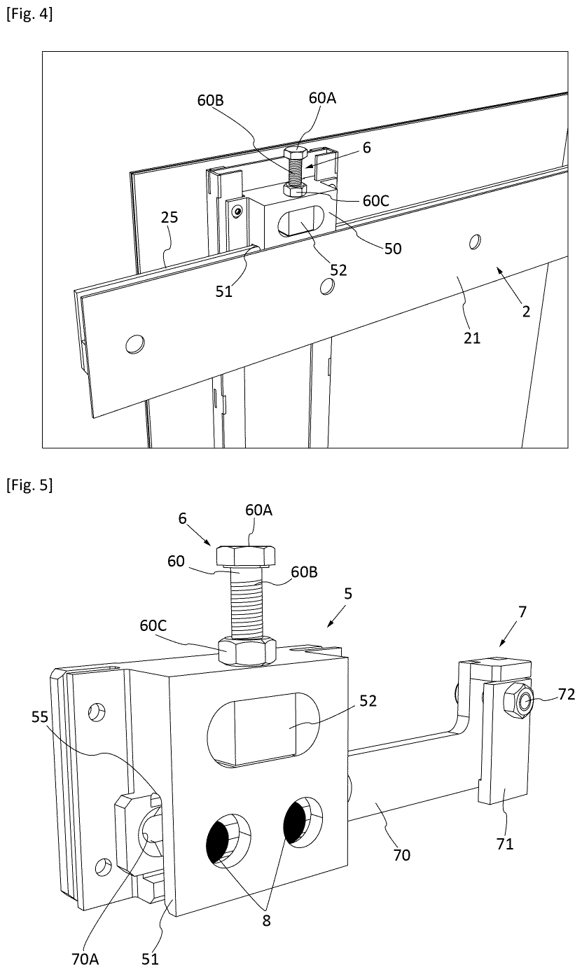

FIG. 5 shows a detailed perspective view of the panel leveling adjustment system of FIG. 1, coupled to one of the second anchoring parts and according to a first embodiment. This view also shows an embodiment of the panel clamping system designed to secure the panel by clamping it to at least one mounting profile.

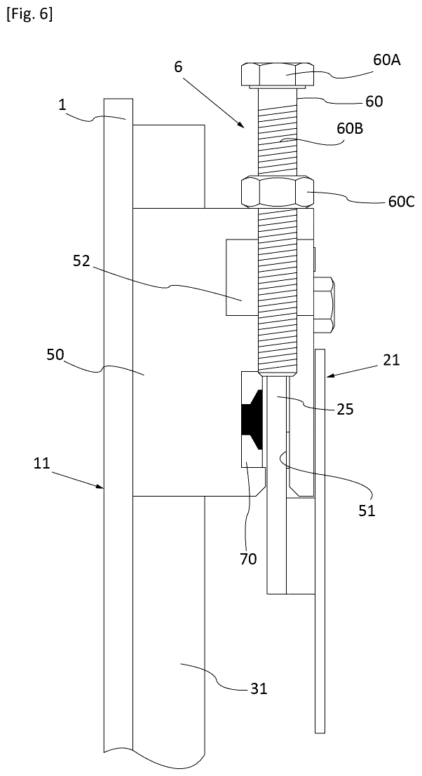

FIG. 6 is a detailed sectional view of the adjustment system shown in FIG. 5, with the panel in the installed position shown in FIG. 2.

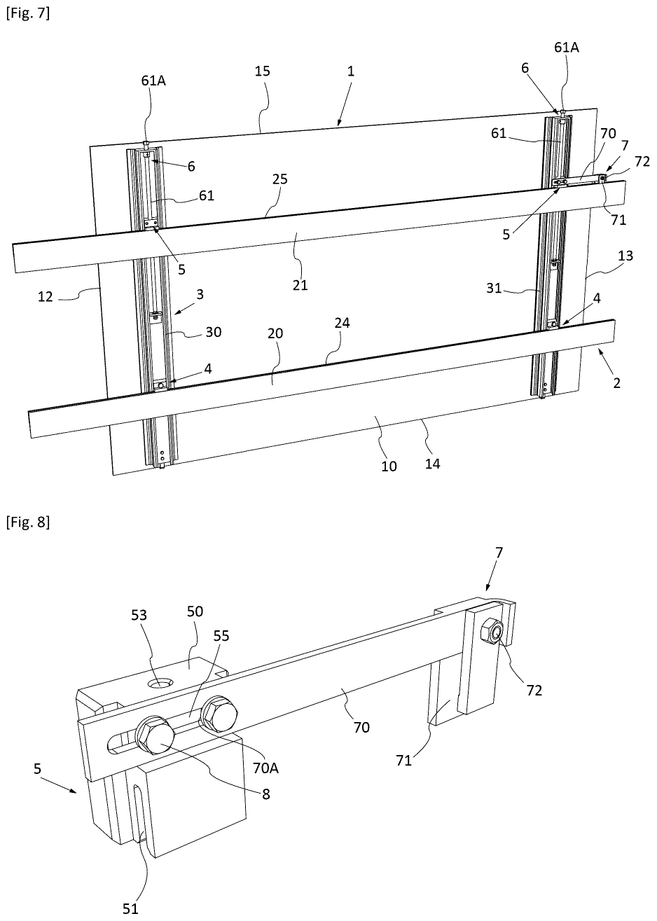

FIG. 7 shows a second example embodiment of a panel according to the invention, showing a different embodiment of the leveling adjustment system coupled to one of the second anchoring parts, the clamping system being the same as that of the panel in FIGS. 1 and 2.

FIG. 8 is a detailed perspective view of a second anchoring part of the adjustment system shown in FIG. 7 and of the clamping system.

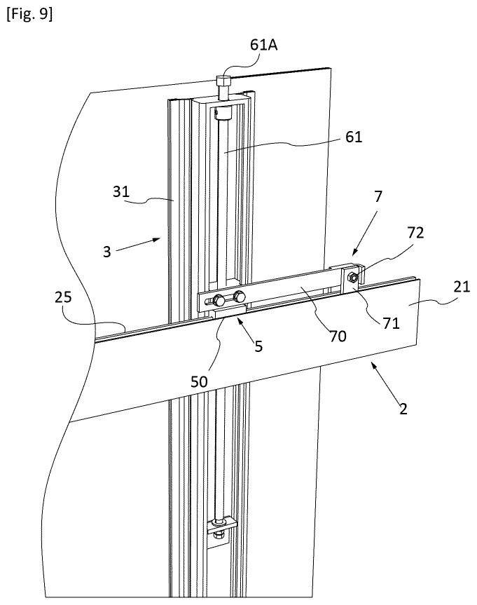

FIG. 9 is a detailed perspective view of the adjustment system of FIG. 7.

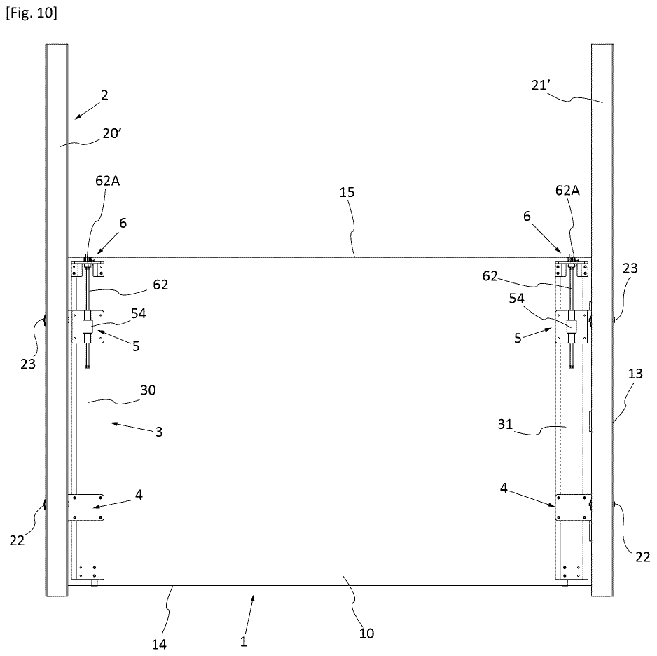

FIG. 10 shows a third example embodiment of a panel according to the invention, showing other types of first and second anchoring parts (for vertical mounting profiles of the building framework), and showing yet another embodiment of the leveling adjustment system, as well as another embodiment of the clamping system.

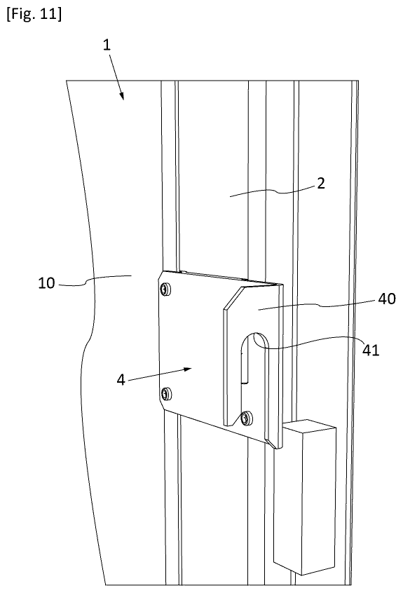

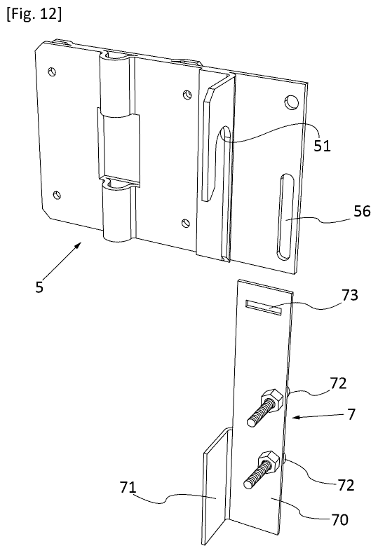

FIG. 11 is a detailed perspective view of one of the first anchoring parts of the panel shown in FIG. 10.

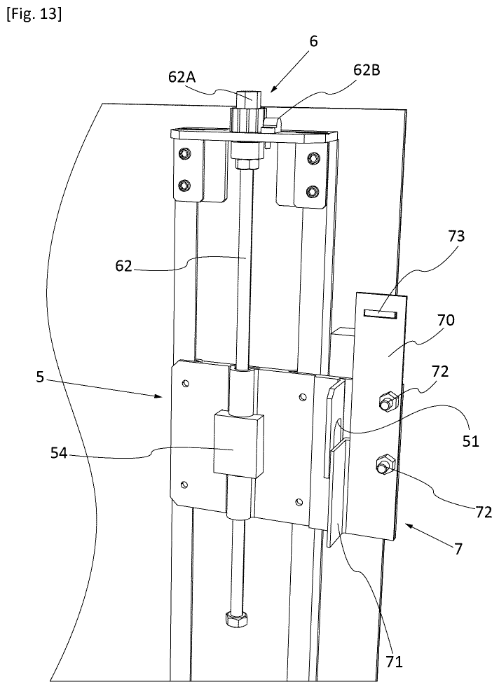

FIG. 12 is an exploded perspective detailed view of one of the second anchoring parts of the panel shown in FIG. 10.

FIG. 13 is a detailed rear perspective view of the panel leveling system and the clamping system shown in FIG. 10.

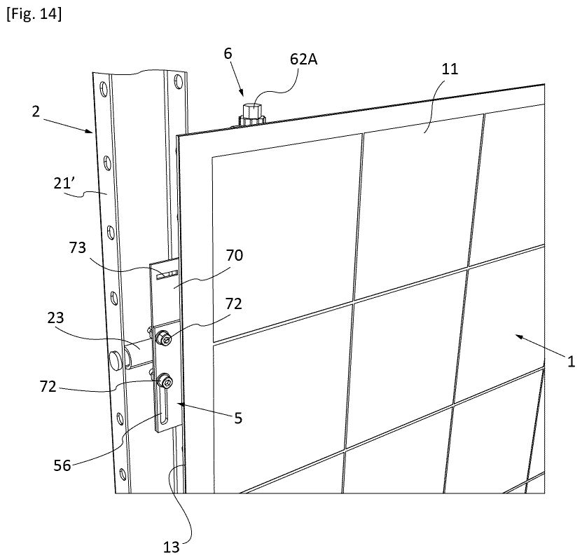

FIG. 14 is a detailed front perspective view of the clamping system for the panel shown in FIG. 10.

The facade panel 1 of the invention shown in the example embodiment of FIGS. 1, 7 and 10 is intended to be attached to a framework 2 of an external wall of a building.

By attaching a plurality of panels 1 (FIG. 2), they can advantageously be used to clad the facade of a building. These panels can also be functional and are for example photovoltaic panels.

The panels 1 are aligned vertically and horizontally. They are removably attached to the framework 2 of the building wall, such as evenly distributed mounting profiles. A panel 1 is usually attached to two mounting profiles of the building framework, such as horizontal mounting profiles 20 and 21 (FIGS. 1, 2 and 7) or vertical mounting profiles 20′ and 21′ (FIG. 10). The space between two panels is very small for photovoltaic panels, namely 10 mm at most.

The panel 1 has a so-called fastening face 10, which is the rear face intended to face and engage with the mounting profiles 20 and 21, or 20′ and 21′, and an opposite face 11 (FIG. 13) corresponding to the front face intended to face the external environment. The panel 1 is rectangular or square, for example, and has two first sides 12 and 13, known as vertical sides, and two opposite second sides 14 and 15, known as horizontal sides. The panel 1 has an fastening system 3 on its fastening face 10 for mounting the panel on the mounting profiles 20 and 21, or 20′ and 21′. The fastening system 3 is designed to hang the panel 1 at least at four points, namely two so-called lower points and two so-called upper points.

When the mounting profiles 20 and 21 are arranged in a horizontal direction as shown in FIGS. 1 and 7, the panel 1, which is hung by its lower and upper points, is then hung directly on said lower 20 and upper 21 mounting profiles. When the mounting profiles 20′ and 21′ are arranged in a vertical direction, as shown in FIG. 10, the panel 1, which is hung by its lower and upper points, is hung on interface parts such as lower pins 22 and upper pins 23, which are secured to the vertical mounting profiles 20′ and 21′ and run in a horizontal direction. For the vertical mounting profiles, a vertical mounting profile generally supports two adjacent panels.

In the usual way, the fastening system 3 is factory-mounted on the fastening face 10 (rear face) of the panel 1 in such a way that the two pairs of lower and upper fastening points correspond to the center distance of the mounting profiles 20 and 21 or that of the pins 22 and 23. According to the invention, the fastening system 3 is not intended to be disassembled and reassembled in situ when the panel 1 is installed. According to the invention, the fastening system 3 is designed to allow, once the panel has been installed parallel to the building facade and hung on at least one mounting profile, precise adjustment of its position without dismantling it, so as to anchor it perfectly on the two mounting profiles 20 and 21, or 20′ and 21′, and level it with the other panels already attached, in order to respect the parallelism between the panels.

Three example embodiments of a panel 1 are disclosed in relation to FIGS. 1 to 6 for the first example, FIGS. 7 to 9 for the second example and FIGS. 10 to 14 for the third example. These examples are by no means exhaustive.

Common to all the example embodiments, the fastening system 3 comprises:
at least two spaced-apart, parallel fastening rails 30 and 31;
a pair of a first anchoring part 4 and a second anchoring part 5 for each of the two fastening rails 30 and 31, the two anchoring parts 4 and 5 of an fastening rail being spaced apart by a distance corresponding to the center distance of the horizontal mounting profiles 20 and 21, or to the distance separating the lower pins 22 and upper pins 23 of the vertical mounting profiles 20′ and 21′;
at least one adjustment system 6 for leveling the panel, said adjustment system being operable when the panel 1 is already in a hung position on the mounting profiles 20 and 21, or 20′ and 21′; and
preferably, a clamping system 7 which clamps the panel 1 once it has been installed on the mounting profiles 20 and 21 or 20′ and 21′, and leveled.

The three example embodiments of panels 1 are different combinations of the design of the anchoring parts 4 and 5, the adjustment system 6 and the clamping system 7.

The pairs of two pairs of anchoring parts 4 and 5 allow the panel 1 to be hung on the mounting profiles 20 and 21, or 20′ and 21′. Leveling the panel 1 consists in arranging said panel so that it is perfectly parallel to adjacent panels already attached, and so that the separation gap with the other panels is constant on all sides 12, 13, 14 and 15. The adjustment system 6 allows the positioning of the panel 1 to be adjusted while it is hung on the mounting profiles 20 and 21, or 20′ and 21′. The adjustment system 6 is designed to be accessible once the panel 1 is in the retained position on the mounting profiles 20 and 21, or 20′ and 21′(without having to dismantle it). As will be described later, the adjustment system 6 advantageously comprises at least one adjusting member 60, 61 or 62 which extends in a plane facing and parallel to the fastening face 10 of the panel and a portion 60A, 61A or 62A of which is accessible from an edge or side, here 15, of the panel, projecting therefrom. This protruding portion 60A, 61A or 62A constitutes the actuating portion of the adjusting member, accessible to the operator when the panel is in the position installed against the building. The adjusting member 60, 61 or 62 is coupled to the fastening system 3 of the panel, in particular to at least one of the second anchoring parts 5, and can be rotated to convert its movement into a translational movement for the panel 1. Thus, there is no need, as in the prior art, to dismantle the panel 1, adjust the positioning of the anchoring parts and reassemble the panel to check the fit; with the operator facing the mounted panel 1, he can act on the adjusting member 60, 61 or 62 located at the rear of the panel, by turning the actuating portion 60A, 61A or 62A which protrudes from an edge of the panel in order to translate the panel. Additionally, the adjustment system 6 allows the operator to perfectly visualize the leveling as he makes the adjustment.

There are two fastening rails 30 and 31 for standard photovoltaic panel dimensions. Depending on the length of the panels, there may be more than two fastening rails with their pair of anchoring parts 4 and 5. The fastening rails 30 and 31 are of the usual type, generally metal profiles with a C-shaped cross-section. The fastening rails 30 and 31 are attached to the rear of the panel, against the fastening face 10, and close to two opposite sides of the panel, in this case close to the sides 12 and 13.

Each fastening rail 30, 31 comprises a pair of the first anchoring part 4 and the second anchoring part 5, which is of a different design from the first. The first anchoring parts 4 of the two fastening rails 30 and 31 form the lower fastening points of the panel 1, while the second anchoring parts 5 of the two fastening rails 30 and 31 form the upper fastening points of the panel 1. In the first and second example embodiments (FIGS. 1 and 7), in which the panel 1 is attached to the so-called lower 20 and upper 21 horizontal mounting profiles, the first anchoring parts 4 engage directly with the lower mounting profile 20, while the second anchoring parts 5 engage with the upper mounting profile 21. In the third example embodiment (FIG. 10), in which the panel 1 is attached to the so-called vertical mounting profiles 20′ and 21′, the first anchoring parts 4 engage with the two vertical profiles 20′ and 21′ in the lower part of the panel via the lower pins 22, while the second anchoring parts 5 engage with the two vertical profiles 20′ and 21′ in the upper part of the panel via the upper pins 23.

Each first anchoring part 4 is intended here to correspond to a lower position anchoring part in the installed position of the panel 1 on the lower mounting profile 20 or on the lower pins 22. Each first anchoring part 4 is attached to an fastening rail 30, 31 and remains fixed during leveling adjustment. Each first anchoring part 4 is preferably removably attached, for example by screws, to each of the fastening rails 30 and 31. Each first anchoring part 4 is designed to be hung so as to straddle either a flange 24 of the lower mounting profile 20, or the lower pin 22 of a vertical mounting profile. To this end, each first anchoring part 4 (FIG. 3 for the example embodiments of the panels in FIGS. 1 and 7, and FIG. 11 for the example embodiment of the panel in FIG. 10) has a body 40 with an inverted U-shaped groove 41. The first anchoring part 4 in the example shown in FIG. 3 is more or less parallelepipedal in shape, and its groove 41 is designed to engage in the manner of a clamp with the flange 24 of the lower mounting profile 20. The first anchoring part 4 in the example shown in FIG. 11 has a groove 41 designed to engage with the lower pin 22 of a vertical mounting profile, in a hook-like profile.

Each second anchoring part 5 is intended here to correspond to an upper position anchoring part in the installed position of the panel 1 on the upper mounting profile 21 or on the upper pins 23 of the vertical mounting profiles. Each second anchoring part 5 is designed to be attached so as to straddle either a flange 25 of the upper mounting profile 21, or the upper pin 23 of a vertical mounting profile. To this end, each second anchoring part 5 has a body 50 with an inverted U-shaped groove 51 (FIGS. 4, 8 and 12 according to the three respective example embodiments). The groove 51 is designed to engage with the flange 25 of the upper mounting profile 20 or with the upper pin 23 of a vertical mounting profile. According to the example embodiments of the leveling adjustment system 6 of the panel 1 used, the second anchoring part 5 remains fixed or can be moved relative to the fastening rail 30, 31 whereupon it is mounted. When the second anchoring part 5 is fixedly mounted on the fastening rail, however, it is preferably removably attached, for example by screws. In the case of the second anchoring part 5 of the first and second example embodiments of the panel 1 (FIGS. 4 and 8), in which the panel 1 engages with the flange 25 of a horizontal mounting profile, the inverted U-shaped groove 51 has a clamp-like profile (as with the associated first anchoring part 4). In the case of the second anchoring part 5 in the third example embodiment of the panel 1 (FIGS. 12 and 13), in which the panel 1 engages with the pin 23 of a vertical mounting profile, the inverted U-shaped groove 51 has a hook-like profile (as with the associated first anchoring part 4).

The adjustment system 6 for leveling the panel 1 comprises at least one adjusting member 60 (FIGS. 1 and 2), or 61 (FIG. 7) or 62 (FIG. 10) according to three respective embodiments. Each adjusting member 60, 61 or 62 engages with a second anchoring part 5. Preferably, an adjusting member 60, 61 or 62 is coupled to each second anchoring part 5.

In all the embodiments, the adjustment system 6 comprises the adjusting member 60, 61 or 62, which is movable to allow the second anchoring part 5 to be moved toward or away from the upper mounting profile 20 or the upper pin 23 of a vertical mounting profile, and as a result to allow the panel 1 to move in a direction parallel to the fastening profiles 30 and 31, in one direction or the other (that is, in an upward or downward vertical direction when the panel is mounted on the building framework 2). The adjusting member 60, 61 or 62 is rotatable and converts its movement into a translational movement for the panel 1.

As a result, in order to be able to adjust the panel properly, that is, to raise either corner of the panel, there must be a screw on each of the two upper anchoring parts.

The adjustment system 6 of the first embodiment (FIGS. 1 and 6) comprises the adjusting member 60, which can be rotated and passes through the second anchoring part 5, by being captured thereby, which second anchoring part is fixed and secured to the associated fastening rail 30 or 31, which in turn is secured to the panel 1. The mobility of the adjusting member 60 in a direction parallel to the fastening rail 30 or 31 (in this case vertical) causes the translation of the anchoring part 5 in this same (vertical) direction, and as a result provides mobility for the panel 1. Preferably, the adjusting member 60 is a screw (FIG. 6). The screw 60 has a head 60A and a threaded body 60B. The threaded body 60B extends parallel to the fastening rail 30 or 31 and engages with a threaded nut 52 which is secured to the inside of the body 50 of the second anchoring part 5. The threaded body 60B has a length adapted to the positioning of the second anchoring part 5 relative to the edge 15 of the panel so that this position coincides with the upper mounting profile 25 in the installed position of the panel. The screw head 60A, which is located on the fastening face 10 side of the panel (at the rear of the panel) protrudes beyond the edge (in this case, the upper edge 15) of the panel 1 so that it is accessible to the operator when the panel 1 is installed on the mounting profiles. The screw head 60A constitutes the actuating portion of the adjusting member 60, this actuating portion 60A always protruding from the edge of the panel to remain accessible. The actuating portion 60A is located at the upper edge 15, as the facade panels are mounted from the bottom up. Since there is still no panel mounted above it that is being attached, the operator has full freedom of access above the panel 1 and to the screw head 60A. The end of the screw opposite the screw head presses on the edge 25 of the mounting profile 21 and by screwing or unscrewing the screw 60, this causes the panel 1 to rise or fall (more specifically, it causes the corner of the panel associated with the location of the adjustment screw to rise or fall), enabling its height to be adjusted and, as a result, its leveling in relation to the adjacent panels below and to the side. When the two anchoring parts 5 of the two fastening rails 30 and 31 are fitted with an adjusting member 60, the operator can adjust the height of the panel 1 even more accurately, in particular by raising or lowering each of the two upper corners of the panel 1, thus adjusting the parallelism of the lower 14 and upper 15 sides of the panel 1. The adjustment is made over a few millimeters (plus or minus 5 mm). Advantageously, the adjusting member 60 further comprises means for locking in position once the adjustment has been completed. In this embodiment, the position-locking means consists of a locknut 60C.

The adjustment system 6 of the second embodiment (FIGS. 7 and 9) is a screw-nut type system, comprising the adjusting member 61 which is rotatably movable, such as a threaded rod (constituting the screw in the screw-nut system), and the second anchoring part 5 (constituting the nut in the screw-nut system) which is carried by the threaded rod 61. The second anchoring part 5 is coupled to the threaded rod 61 by its body 50, which comprises an internal thread 53 therethrough (FIG. 8). Rotation of the adjusting member 61, in this case rotation of the threaded rod, results in translation of the second anchoring part 5. The threaded rod 61 comprises a gripping portion 61A at one of its distal ends, which constitutes the actuating portion. Rotating the threaded rod 61 in one direction or the other via the actuating portion 61A causes the second anchor 5 to move upward or downward, and as a result translates the panel 1 to thus accurately adjust its level. The use of a threaded rod has the advantage of extending over a long length to position the second anchoring part 5 at a distance from the edge 15 of the panel. The threaded rod could be fitted with a position-locking element, such as a spring-return gear element.

The adjustment system 6 of the third embodiment (FIGS. 10 and 13) comprises the adjusting member 62, which is rotatable in the form of a worm with a gear element 62B. The worm 62 carries the second anchoring part 5. Advantageously, the gear element 62B is resiliently biased to automatically lock the screw in position, and as a result to lock the second anchoring part 5 and thus the panel 1 in position. The second anchoring part 5 is coupled to the worm 62, comprising a threaded nut 54 through which said worm passes. Rotation of the worm 62 causes translation of the second anchoring part 5. Rotation in one direction or the other causes the second anchoring part 5 to move upward or downward, and as a result causes the panel 1 to move upward or downward, enabling the panel to be leveled. The use of a worm has the advantage of extending over a long length to position the second anchoring part 5 at a distance from the edge 15 of the panel.

Once the panel 1 has been leveled, it is preferably locked in position by the clamping system 7. The clamping system 7 is attached to at least one anchoring part, preferably to at least one of the second anchoring parts 5. Preferably, the clamping system 7 is removably attached to a second anchoring part 5, and is adjustable in position relative to said second anchoring part 5. The clamping system 7 is designed to engage with the mounting profile 21 or the pin 23 of the building framework in the mounted position of the panel 1 and to lock the panel 1 in position, while being accessible to the operator at the edge of the panel when the panel is already installed. The clamping system 7 comprises a part 70 attached to the second anchoring part 5, a part 71 designed to engage with the building framework 2 (mounting profile 21 or pin 23) and clamping means 72 locking the engagement part 71 in position with the building framework 2. The part of the clamping system 7 carrying the clamping means 72 protrudes from the edge 13 of the panel 1. The clamping system 7 is of different design depending on the type of mounting profile of the building framework 2.

The example panels 1 shown in FIGS. 1, 2 and 7, which are attached to horizontal mounting profiles 20 and 21, feature the same clamping system principle 7 (FIGS. 5 and 8). The part 70 attached to the second anchoring part 5 is elongated in the manner of an arm to be attached to the anchoring part 5 and extends beyond the edge 13 of the panel to the part 71 engaging with the profile 21. The engagement part 71 thus protrudes from the edge of the panel and receives the clamping means 72. More specifically, the arm 70 extends in a plane parallel to the fastening face 10 of the panel and perpendicular to fastening rail 30 or 31. The arm 70 is held in or against a receiving housing 55 of the body 50 of the second anchoring part 5, which is separate from the groove 51 designed to engage with the flange 25 of the mounting profile 21. The arm 70 is removably attached to the second anchoring part 5 by at least one screw 8 which passes through a hole 70A in said arm. In addition, the arm 70 can be adjusted in position in the direction of its longitudinal axis to adjust the position of the engagement part 71 protruding from the edge of the panel 1. For this purpose, the hole 70A is oblong in shape. The engagement part 71 is shaped like a jaw to sandwich the flange 25 of the profile 21 (FIGS. 2 and 7). The clamping means 72 engage with the engagement part 71 and are able to lock it to the flange 25 of the profile. The clamping means 72 are, for example, bolted, the nut being a fixed stamped piece in one of the parts of the jaw 71.

The example of a panel 1 shown in FIG. 10, which is attached to the pin 23 of a vertical mounting profile 21′, features another clamping system 7 (FIGS. 11 to 13). The clamping system 7 comprises a plate which comprises the part 70 for fastening to the second anchoring part 5, the fastening preferably being removable, and the engagement part 71 which is intended to engage with the pin 23 of the mounting profile, the clamping means 72 engaging here with the fastening part 70. In particular, the plate of the clamping system 7 can be moved relative to the second anchoring part 5, which engages with the pin 23 via its groove 51, so that the engagement part 71 can be brought into abutment against the pin 23 to enclose it in the groove 51 of the second anchoring part 5. The mobility of the plate and therefore of the engagement part 71 is achieved by the presence of an oblong slot 56 in the second anchoring part 5, extending parallel to the fastening rail 30 or 31 (and therefore intended to extend transversely to the pin 23 of the mounting profile). Once the engagement part 71 is in the abutment position, the clamping means 72 are activated. The clamping means 72 are preferably bolted. At least one screw of the clamping means 72 passes through the slot 56 of the second anchoring part 5. The fastening part 70 with the second anchoring part is the part that protrudes from the edge of the panel to be accessible so that the operator can implement the clamping means 72; this fastening part 70 is also adjustable in position relative to the edge of the panel 1 (in a direction perpendicular to the edge of the panel) owing to an oblong hole 73 made in said fastening part 70 and extending perpendicularly to the fastening rail 30 or 31.

The method for installing a panel 1 is now described.

The operator mounts the panel on the mounting profiles by hooking the first anchoring parts 4 and the second anchoring parts 5 after the profiles 20 and 21, respectively, or the pins 22 and 23 of the mounting profiles 20′ and 21′.

Then, to adjust the level of the panel, that is its parallelism with respect to the other panels already mounted, in particular those positioned below and on one of the sides, the operator screws or unscrews the actuating portion 60A or 61A or 62A of the adjusting member(s) 60 or 61 or 62, respectively, the actuating portion projecting beyond the edge of the panel above which another panel is to be mounted later. Once the panel 1 has been leveled by the adjustment system 6, the adjustment system 6 is locked in position, either manually in the first example embodiment by screwing on the locknut 60C, or automatically with the spring-return gear 62C of the third example embodiment.

Finally, to ensure that the leveled panel 1 is held securely in place, so that it does not accidentally become detached from the first and second anchoring parts 4 and 5, the operator locks the position using the clamping system 7. The clamping system 7 comprises its engagement part 70 or 71 with one of the mounting profiles protruding from one of the edges of the panel proximate to which no adjacent panel is yet mounted. Preferably, the engagement part 70 or 71 extends in a direction perpendicular to that of the adjusting member 60, 61 or 62. The operator activates the clamping means 72, which are directly accessible in front of him, and thus clamps the panel 1 in position.

1. A building facade panel, having two opposite faces, including a fastening face, comprising:
on the fastening face, a fastening system which comprises at least two parallel, spaced-apart fastening rails,
at least a first anchoring part and a second anchoring part, which are spaced apart and coupled to each of the fastening rails,
an adjustment system for leveling the panel, comprising at least one adjusting member which is arranged on the fastening face side and which engages with the fastening system, the adjusting member further comprising an actuating portion which protrudes from an edge of the panel.

2. The building facade panel according to claim 1, wherein the adjusting member is a rotary member configured to transmit a translational movement to the panel.

3. The building facade panel according to claim 1, wherein the adjusting member is coupled to the second anchoring part of a fastening rail.

4. The building facade panel according to claim 1, wherein the adjusting member is a screw which engages with a second anchoring part, the second anchoring part being fixedly secured to the associated fastening rail and the panel being capable of translational movement when the screw is actuated.

5. The building facade panel according to claim 1, the adjustment system is a screw-nut system and comprises the adjusting member as a screw and the second anchoring part as a nut, the second anchoring part being capable of translational movement when the screw is actuated.

6. The building facade panel according to claim 1, wherein the adjustment system is a worm system, comprising the adjusting member, which is a worm and carries the second anchoring part, and a gear element for the worm, the second anchoring part being capable of translational movement when the worm is actuated.

7. The building facade panel according to claim 1, wherein the adjustment system comprises a position-locking element for the adjusting member.

8. The building facade panel according to claim 1, wherein the first and second anchoring parts each comprise a female shape intended to engage in the mounted position of the panel with a male shape of the building framework.

9. The building facade panel according to claim 1, comprising a system for clamping the panel in the mounted position.

10. The building facade panel according to claim 9, wherein the clamping system is attached to a second anchoring part, and comprises a portion which protrudes from an edge of the panel and which comprises clamping means locking said protruding portion in position.

11. The building facade panel according to claim 10, wherein the clamping system is removably attached to said second anchoring part and is adjustable in position relative to said second anchoring part so as to adjust the position of the protruding portion comprising the clamping means.

12. A method of attaching a building facade panel according to claim 1, to mounting profiles of the framework of a building, the method comprising:
hanging the panel via the first and second anchoring parts,
once the panel has been hung, leveling the panel by actuating the actuating portion of at least one adjusting member projecting from one of the edges of the panel.

13. The building façade panel according to claim 1, wherein the building facade panel is a photovoltaic building facade panel.

14. The building facade panel according to claim 3, wherein the adjustment system comprises two adjusting members which are each coupled to the second anchoring part of the two fastening rails.

15. The building facade panel according to claim 7, wherein the position-locking element for the adjusting member is a locknut when the adjusting member is a screw or a spring-return gear element when the adjusting member is a worm.

16. The building facade panel according to claim 8, wherein the female shape is an inverted U shape.

17. The building facade panel according to claim 8, wherein the male shape of the building framework is a flange of a mounting profile or pin attached to a mounting profile.

18. The building facade panel according to claim 10, wherein the clamping is by bolting.

19. The method according to claim 12, wherein the leveling of the panel is carried out by screwing or unscrewing the actuating portion.

20. The method according to claim 12, further comprising, after leveling, clamping the panel in position by actuating clamping means of the clamping system, the clamping means protruding from one of the edges of the panel and being capable of locking the fastening of one of the anchoring parts to one of the mounting profiles of the building framework.
